(19) United States
(12) Patent Application Publication
(10) Pub. No.: US 2014/0026546 A1
(43) Pub. Date: Jan. 30, 2014

(54) Regeneration Valve for a Hydraulic Circuit

(71) Applicants: Kevin A. Bacon, Dunlap, IL (US); Gang Victor Wen, Dunlap, IL (US); Wesley Thomas Payne, Plainfield, IL (US)

(72) Inventors: Kevin A. Bacon, Dunlap, IL (US); Gang Victor Wen, Dunlap, IL (US); Wesley Thomas Payne, Plainfield, IL (US)

(73) Assignee: CATERPILLAR, INC., Peoria, IL (US)

(21) Appl. No.: 13/557,817

(22) Filed: Jul. 25, 2012

(51) Int. Cl. F16K 27/02; F15B 13/00

(52) U.S. Cl. 60/325; 251/336

(57) ABSTRACT

A regeneration valve for a hydraulic circuit may include a valve element for controlling flow between first, second, and third ports. The valve element may be formed with a flow slot that generates a slot flow force when hydraulic fluid flows therethrough. The flow slot may be configured so that a predetermined fluid low rate may generate a slot flow force sufficient to actuate the valve element from a first position to a second position. In the second position, the valve element may divert a portion of flow from the second port to the first port is diverted to the third port. The flow slot may be configured so that the fluid exits the slot at an exit angle that varies as the valve element moves between first and second positions, thereby to provide a more uniform flow force across the range of travel of the valve element.

### TECHNICAL FIELD

The present disclosure relates to valves and, more particularly, to regeneration valves used in hydraulic circuits to direct discharge flow from a rod end of a cylinder to a head end.

### BACKGROUND

In general, a double-acting hydraulic cylinder may include a piston disposed in a cylinder chamber to define a head end and a rod end. A pump may be provided for delivering pressurized hydraulic fluid to the cylinder, and a reservoir may receive hydraulic fluid that is discharged from the cylinder. An implement control valve controls fluid communication of the head and rod ends of the cylinder with the pump and reservoir. For example, when the cylinder is to be retracted, the implement control valve may move to a cylinder retract position in which the rod end fluidly communicates with the pump and the head end fluidly communicates with the reservoir. In this retract configuration, the rod end is at a higher pressure and the head end is at a lower pressure, so that the piston moves toward the head end. Alternatively, when the cylinder is to be extended, the implement control valve may move to a cylinder extend position in which the rod end fluidly communicates with the reservoir and the head end fluidly communicates with the pump. In this extend configuration, the rod end is at a lower pressure and the head end is at a higher pressure, so that the piston moves toward the rod end.

Regeneration valves are generally known for use in hydraulic circuits to increase flow rate of hydraulic fluid between the head end and the rod end of the cylinder under certain operating conditions. In a track type tractor, for example, a regeneration valve may be used in a blade lift circuit to increase the rate at which the blade is lowered under the force of gravity. When the blade is to be lowered, the implement control valve is placed in the cylinder extend position so that the rod end fluidly communicates with the reservoir and the head end fluidly communicates with the pump. The regeneration valve is configured to divert at least a portion of the hydraulic fluid exiting the rod end to the head end instead of back to the reservoir. This regenerative flow is combined with incoming flow from the pump to provide a much higher flow rate to the head end of the cylinder. The increased flow rate may increase the rate at which the cylinder extends.

Additionally or alternatively, the increased flow rate prevents cavitation in the head end. When the blade is dropped under the force of gravity, the piston rapidly moves toward the rod end. Rapid movement of the piston in the rod end direction may exceed the pump capacity to deliver fluid to the head end, thereby creating a void or cavitation in the head end. The increased flow to the head end provided by the regeneration valve helps prevent such a void from occurring.

Conventional regeneration valves are overly complicated and expensive. Typical regeneration valves are pilot pressure activated, which requires pressure sensing components to determine when a threshold pressure differential has been reached to trigger actuation of the regeneration valve. The need for these additional components increases the cost and complexity of the valve and its assembly. Conventional regeneration valves are also difficult to scale down, and therefore are often not used in smaller, more cost sensitive products that would still benefit from the inclusion of a regeneration valve.

U.S. Pat. No. 6,699,311 to Smith et al. discloses a hydraulic circuit having a quick drop valve to facilitate rapid lowering of an implement. The quick drop valve includes a valve member that is movable between a first position, corresponding to a non-quick drop hydraulic fluid flow path of the fluid circuit, and a second position, corresponding to a quick drop hydraulic flow path of the fluid circuit. The valve member is biased toward the first position by a spring and a pilot pressure supplied to an actuation chamber of the quick drop valve. Smith et al. disclose that the pilot pressure may be adjusted through the use of a solenoid valve. As a result, the valve member may be locked in the first position when the solenoid valve is open to communicate pilot pressure, and may be unlocked to permit movement to the second position when the solenoid valve is closed, thereby reducing or eliminating the pilot pressure. An operator controlled leer is provided to actuate the solenoid valve, thereby to switch the valve member between locked and unlocked states. While the '311 patent allows an operator to more precisely control operation in non-quick drop and quick drop modes, it adds to the complexity of the machine by requiring additional components and user operated controls, and still relies on fluid pressure to control the position of the valve member.

### SUMMARY OF THE DISCLOSURE

In accordance with one aspect of the disclosure, a regeneration valve may be provided for a hydraulic circuit having a hydraulic fluid flowing therethrough. The regeneration valve may include a housing defining a first port, a second port, and a third port, and a chamber formed in the housing and fluidly communicating with the first, second, and third ports. A valve element may be disposed in the chamber and movable between a first position, in which the second port fluidly communicates with the first port, and a second position, in which the second port fluidly communicates with the third port. A resilient member may be coupled to the valve element and configured to apply a biasing force on the valve element toward the first position. A flow slot may be formed in the valve element and fluidly communicates with the hydraulic fluid flowing through the chamber, the flow slot being configured to define a slot fluid flow that generates a slot flow force acting on the valve element that may be sufficient to actuate the valve element to the second position at a predetermined hydraulic fluid flow rate from the second port to the first port.

In another aspect of the disclosure that may be combined with any of these aspects, a hydraulic circuit for a machine implement may be provided that includes a pressurized hydraulic fluid source, a fluid reservoir, and a hydraulic cylinder having a cylinder head end and a cylinder rod end. A regeneration valve may include a housing defining a first port fluidly communicating with the fluid reservoir, a second port fluidly communicating with one of the cylinder head end and the cylinder rod end, and a third port fluidly communicating with both the pressurized fluid source and a remaining one of the cylinder head end and the cylinder rod end. A chamber may be formed in the housing and fluidly communicates with the first, second, and third ports, and a valve element may be disposed in the chamber and movable between a first position, in which the second port fluidly communicates with the first port, and a second position, in which the second port fluidly communicates with the third port. A resilient member may be coupled to the valve element and configured to apply a biasing force on the valve element toward the first position. A flow slot may be formed in the valve element and fluidly communicates with the hydraulic fluid flowing through the chamber, the flow slot being configured to define a slot fluid flow that generates a slot flow force acting on the valve element that may be sufficient to actuate the valve element to the second position at a predetermined hydraulic fluid flow rate from the second port to the first port.

In another aspect of the disclosure that may be combined with any of these aspects, the valve element may include first and second lands coupled by a spool rod.

In another aspect of the disclosure that may be combined with any of these aspects, the flow slot may be formed in the first land.

In another aspect of the disclosure that may be combined with any of these aspects, the flow slot may be formed in both the first and second lands.

In another aspect of the disclosure that may be combined with any of these aspects, the hydraulic circuit may include a hydraulic cylinder having a cylinder rod end and a cylinder head end, and the first port may fluidly communicate with a fluid reservoir, the second port may fluidly communicate with the cylinder rod end, and the third port may fluidly communicate with the cylinder head end.

In another aspect of the disclosure that may be combined with any of these aspects, the housing may define a resilient member chamber configured to receive the resilient member, and a pilot passage may fluidly communicate between the resilient member chamber and a pilot signal.

In another aspect of the disclosure that may be combined with any of these aspects, the slot fluid flow may exit the slot at an exit angle, and the slot may be configured to have a larger exit angle with the valve element in the first position and a smaller exit angle with the valve element in the second position.

In another aspect of the disclosure that may be combined with any of these aspects, the flow slot may be formed in a periphery of the valve element and may include opposed side walls joined by a terminal end wall, the flow slot defining a terminal end adjacent the terminal end wall and an open end opposite the terminal end.

In another aspect of the disclosure that may be combined with any of these aspects, the flow slot may have a physical attribute having a first value at the flow slot open end and a second value, different from the first value, at the flow slot terminal end.

In another aspect of the disclosure that may be combined with any of these aspects, the physical attribute may be selected from the group consisting of a slot depth, a slot width, a slot length, and a slot radius of curvature.

In another aspect of the disclosure that may be combined with any of these aspects, the flow slot may have a first slot depth and a first slot width at the flow slot open end, and a second slot depth and a second slot width at the flow slot terminal end, wherein the first slot depth may be different from the second slot depth and the first slot width may be different from the second slot width.

In another aspect of the disclosure that may be combined with any of these aspects, the second port may fluidly communicate with the cylinder rod end and the third port may fluidly communicate with the cylinder head end.

### BRIEF DESCRIPTION OF THE DRAWINGS

FIG. 1 is a side elevational view of a track-type tractor constructed according to this disclosure.

FIG. 2 is a schematic diagram of a hydraulic fluid circuit used in the tractor of FIG. 1 that includes a regeneration valve.

FIG. 3 is an enlarged side elevation view, in cross-section, of a portion of the regeneration valve of FIG. 2.

FIG. 4 is an enlarged view side elevation view, in cross-section, of a portion of the regeneration valve of FIG. 2 illustrating fluid flow exiting a slot at an exit angle.

FIG. 5 is an enlarged view of an alternative embodiment of a valve element for the regeneration valve of FIG. 2.

### DETAILED DESCRIPTION

Embodiments of a regeneration valve are disclosed for redirecting hydraulic fluid from a cylinder rod end to a cylinder head end during rapid extension of the cylinder rod. The regeneration valve may include a valve element that is responsive to a rate of fluid flow through the valve to automatically actuate from a first position, in which the cylinder rod end fluidly communicates with a fluid reservoir, to a second or regeneration position, in which the cylinder rod end fluidly communicates with both the fluid reservoir and the cylinder head end. More specifically, the valve element may be configured, such as with a flow slot, to generate a slot fluid flow that creates a resultant slot flow force acting on the valve element. The slot flow force may be oriented to drive the valve element toward the second position. The slot flow force may vary based on the rate of fluid flow through the slot. Accordingly, the valve element may modulate between the first and second positions based on the slot flow rate. The flow slot may be tuned so that the slot flow force is sufficient to move the valve element toward the second position at a predetermined flow rate. Additionally, when the slot flow rate is reduced or stopped, the slot flow force may be also reduced or eliminated, so that the valve element may automatically return to the first position.

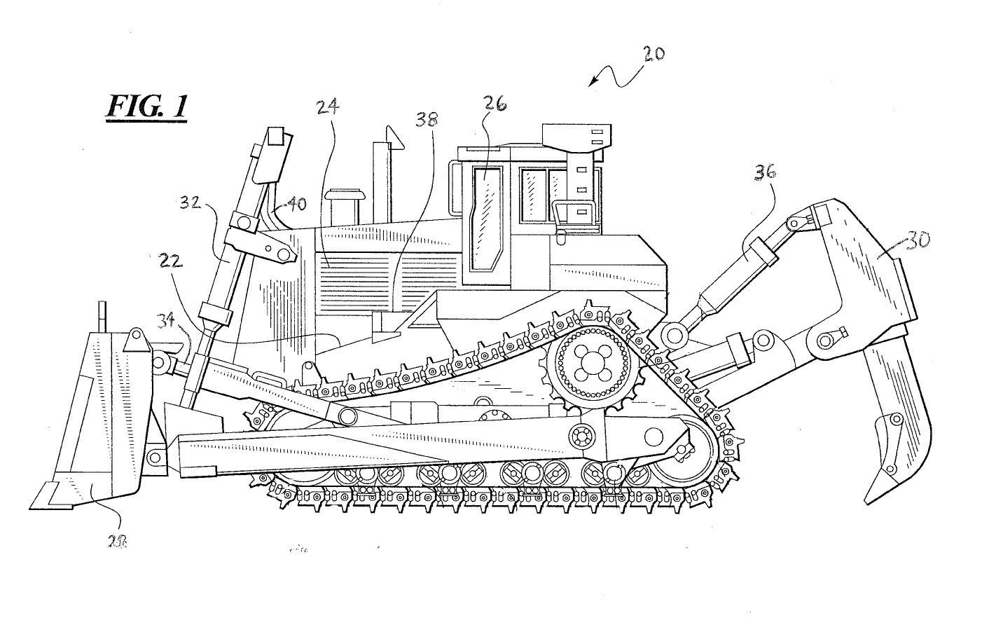

Referring to FIG. 1, a track-type tractor constructed according to the present disclosure is generally referred to by reference numeral 20. While this disclosure is provided with primary reference to a track-type tractor, it will be understood that the teachings of this disclosure may be employed with equal efficacy in conjunction with other machines, such as loaders, excavators, and pipelayers. Still further, the machine may have any type of track, wheel, or other ground engaging member used for transportation.

In the illustrated embodiment, the track-type tractor 20 may include a chassis 22 supporting an engine 24. An operator cab or seat 26 also may be supported by the chassis 22 behind the engine 24. In some embodiments, the track-type tractor 20 may be remotely controlled. Various tools or implements may be mounted on the tractor 20, such as, but not limited to, a blade 28 and a ripper 30. Hydraulic cylinders may be used to lift or otherwise move the tools and implements. For example, a pair of lift cylinders 32 (only one shown in FIG. 1) and a tilt cylinder 34 may be provided to manipulate the blade 28. Similarly, a ripper cylinder 36 may be provided to manipulate the ripper 30. A hydraulic pump 38 may be operatively coupled to the engine 24 to provide pressurized hydraulic fluid via hoses 40 to hydraulic cylinders 32, 34, 36.

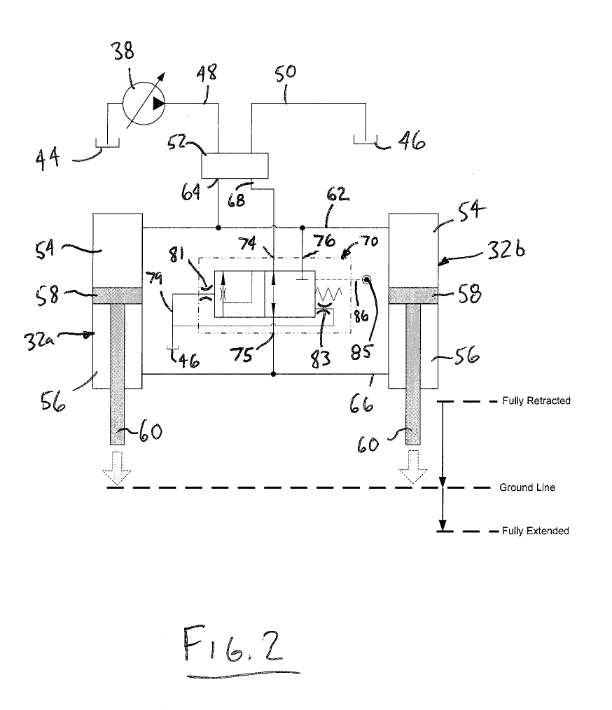

As best shown in FIG. 2, the tractor 20 may include a hydraulic circuit 42 for operating one or more of the hydraulic cylinders. The hydraulic circuit 42 may include a pressurized hydraulic fluid source, which may be the hydraulic pump 38. The hydraulic pump 38 may include an inlet for drawing hydraulic fluid from a fluid source 44 and an outlet for delivering pressurized hydraulic fluid to the circuit 42. A fluid reservoir 46, which may be provided at substantially atmospheric pressure, may receive hydraulic fluid from the circuit 42.

A pump conduit 48 and a reservoir conduit 50 may fluidly couple the pump 38 and reservoir 46 to a directional control valve 52. The control valve 52 may selectively controls fluid communication from the pump 38 and reservoir 46 to one or more hydraulic mechanisms actuated by the hydraulic circuit 42. For example, the control valve 52 may be a four position, four way valve of conventional design that includes a position for each of: (1) a raising blade operation; (2) a holding blade operation; (3) a controlled lowering blade operation; and (4) a floating blade operation. Alternatively, the control valve 52 may have any other configuration, including a single valve or multiple valves. Additionally, the control valve 52 may be pilot actuated, electrically actuated, or mechanically actuated.

The hydraulic circuit 42 may further include hydraulic mechanisms, such as first and second lift cylinders 32a, 32b operably coupled to the blade 28. Each of the lift cylinders 32a, 32b may be a double acting cylinder that includes a head end 54, a rod end 56, a piston 58 slidably disposed therein, and a piston rod 60 coupling the piston 58 to the blade 28. The blade 28 may be acted on by gravity such that the weight of the blade 28 establishes a generally downwardly dropping direction tending to extend the lift cylinders 32a, 32b. A first conduit 62 may fluidly communicate between the head ends 54 of the cylinders 32a, 32b and a first outlet 64 of the control valve 52, while a second conduit 66 may fluidly communicate between the rod ends 56 and a second outlet 68 of the control valve 52.

In operation, the control valve 52 may be actuated to deliver pressurized hydraulic fluid from the pump 38 to ends of the lift cylinders 32a, 32b that are selected according to a desired blade operation. For example, if the blade is to be raised, the control valve 52 may be moved to a position in which pressurized hydraulic fluid is directed to the rod ends 56 and the head ends 54 may be placed in fluid communication with the reservoir 46, so that the pistons 58 will move upwardly to raise the blade. Conversely, to lower the blade 28, the control valve 52 may move to a position in which pressurized hydraulic fluid is directed to the head ends 54 while the rod ends 56 fluidly communicate with the reservoir 46, so that the pistons 58 move downwardly to lower the blade.

A regeneration valve 70 may be provided to assist with rapid movement of the pistons 58 toward the rod ends 56. In the illustrated embodiment, movement of the pistons 58 toward the rod ends 56 may extend the lift cylinders 32a, 32b, while in an alternative configuration the lift cylinders 32a, 32b may retract. Returning to the exemplary embodiment, certain blade lowering operations may use the gravity force on the blade to execute a quick drop, which may rapidly move the pistons 58 downwardly using the gravity force acting on the blade 28. The rapid movement of the pistons 58 may cavitate the head ends 54 of the cylinders 32a, 32b, such that the head ends 54 are not completely filled with hydraulic fluid. Since the cavitated head ends 54 of the cylinders 32a, 32b must be filled with fluid from the pump 38 after the blade 28 comes to rest (typically once it hits the ground), a considerable lag time occurs before sufficient downward force can be applied to the blade 28 for penetrating the ground. The regeneration valve 70 may be configured to divert a portion of fluid in the rod ends 56 that would normally flow to the reservoir 46 to the head ends 54, thereby to minimize cavitation and resulting lag time.

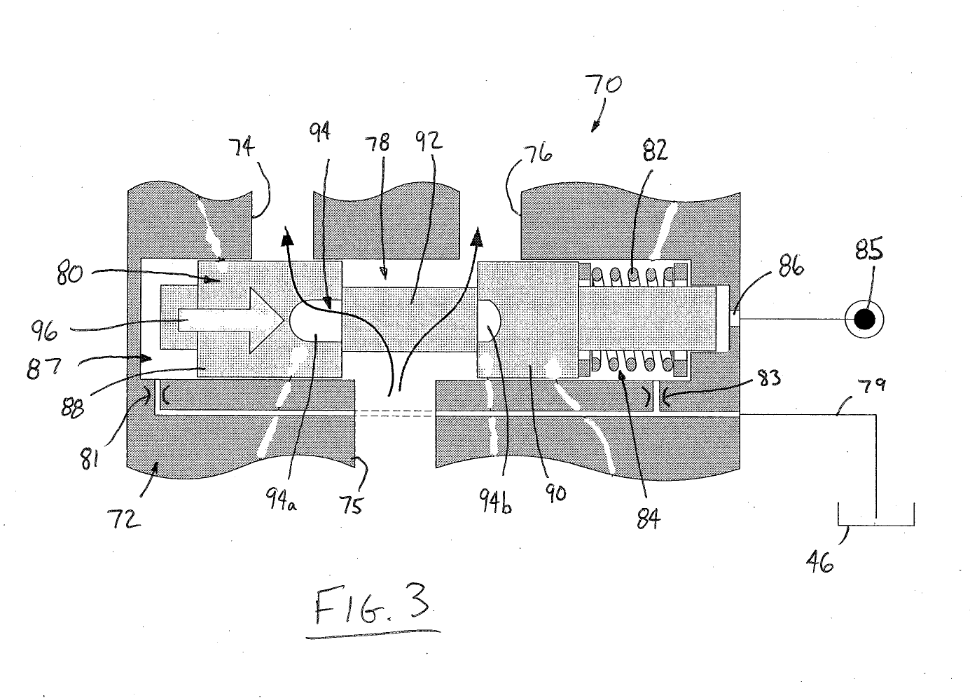

As best shown in FIGS. 2 and 3, the regeneration valve 70 may include a housing 72 defining a first port 74 fluidly communicating with the control valve 52, a second port 75 fluidly communicating with the cylinder rod ends 56, and a third port 76 fluidly communicating with the cylinder head ends 54. In an alternative embodiment, the second and third ports 75, 76 may be swapped, so that the second port 75 fluidly communicates with the cylinder head ends 54 and the third port 76 fluidly communicates with the cylinder rod ends 56. A chamber 78 may be formed in the housing and may fluidly communicate with the first, second, and third ports 74, 75, and 76.

A valve element 80 may be disposed in the chamber 78 and movable between a first position (shown in FIG. 2), in which the second port 75 fluidly communicates with the first port 74, and a second or regeneration position (shown in FIG. 3), in which the second port 75 fluidly communicates with the third port 76 and restricts fluid flow from the second port 75 to the first port 74. A resilient member 82 may be operably coupled to the valve element 80 and configured to apply a biasing force on the valve element 80 toward the first position. In the exemplary embodiment, the resilient member 82 may be formed as a spring disposed in a resilient member chamber 84. The housing 72 may further define a pilot passage 86 that fluidly communicates between the resilient member chamber 84 and a pilot signal 85. The pilot signal 85 may be provided by a dedicated pilot pump (not shown), the hydraulic pump 38, or any other source of pressurized hydraulic fluid. The opposite ends of the chamber 78, such as a chamber end 87 and the resilient member chamber 84, may also fluidly communicate with the reservoir 46 through a drain line 79 to facilitate movement of the valve element 80. First and second flow restrictors 81, 83 may be provided in the drain line 79 to control flow rate through the drain line 79.

The valve element 80 may be configured to be responsive to a rate of fluid flow through the chamber 78 to automatically actuate from the first position to the second position. In an exemplary embodiment, the valve element 80 may be provided as a spool valve having first and second lands 88, 90 joined by a spool rod 92. A flow slot 94 may be formed in the valve element 80 and oriented to fluidly communicate with hydraulic fluid flowing through the chamber 78. As used herein, the term “slot” may encompass an orifice, a cavity, a pocket, and indent, a recess, a channel, or any other type of space or void formed in the valve element 80 that defines a discrete fluid flow path.

As shown in FIG. 3, the flow slot may include a flow slot first segment 94a formed in the first land 88 and a flow slot second segment 94b formed in the second land 90, although other slot configurations and locations may be used. The flow slot 94 may define a slot fluid flow that generates a slot flow force 96 acting on the valve element 80. The flow slot 94 may be configured so that the slot flow force 96 generated at a predetermined hydraulic fluid flow rate from the second port 75 to the first port 74 is sufficient to overcome the biasing force of the resilient member 82, thereby to actuate the valve element 80 from the first position to the second position.

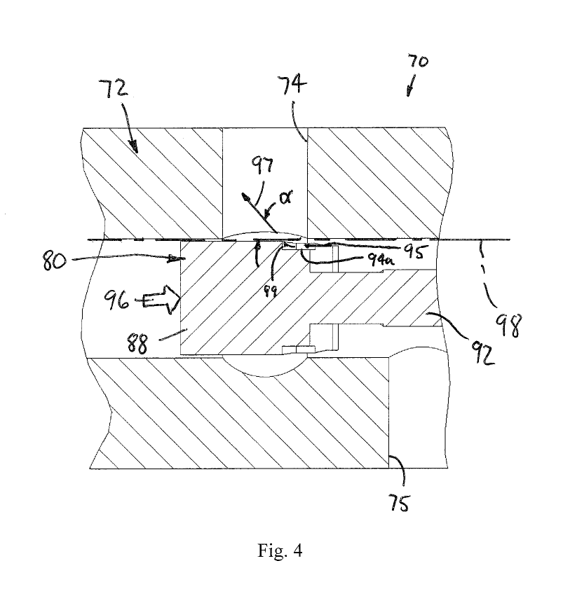

The flow slot 94 may further be configured to maintain a slot flow force 96 sufficient to overcome the biasing force across the entire range of travel of the valve element 80. In the illustrated embodiment, the slot flow force 96 may be primarily dependent on a pressure differential across the valve element 80 and an exit angle α of the fluid as it leaves the flow slot 94. FIG. 4 shows an enlarged view of a portion of the regeneration valve 70, including the valve element 80. The flow slot first segment 94a is shown formed in the first land 88 to define a slot fluid flow 95 traveling through the slot. The fluid may leave a slot terminal end 99 of the flow slot first segment 94a along an exit flow path 97 that is generally oriented along the exit angle α relative to a reference line 98 that is substantially parallel to the longitudinal direction of travel of the valve element 80. The flow force 96 generated by the slot 94 may be directly proportional to the pressure differential across the valve element 80 and inversely proportional to the exit angle α of the fluid as it leaves the slot.

In the exemplary embodiments, the pressure differential across the valve element 80 may decrease as the valve element 80 moves from the first position to the second position (as the third port 76 becomes more open), thereby tending to decrease the magnitude of the slot flow force 96. To compensate for the reduction in differential pressure, the flow slot 94 may be configured to adjust the exit angle α of the fluid from a larger exit angle when the valve element 80 is in the first position to a smaller exit angle when the valve element 80 is in the second position. The larger exit angle may tend to reduce the slot flow force 96, while the smaller exit angle may tend to increase slot flow force 96. Thus, by varying the exit angle of the fluid to compensate for the varying pressure differential, a more consistent slot flow force 96 may be achieved over the full range of travel of the valve element 80.

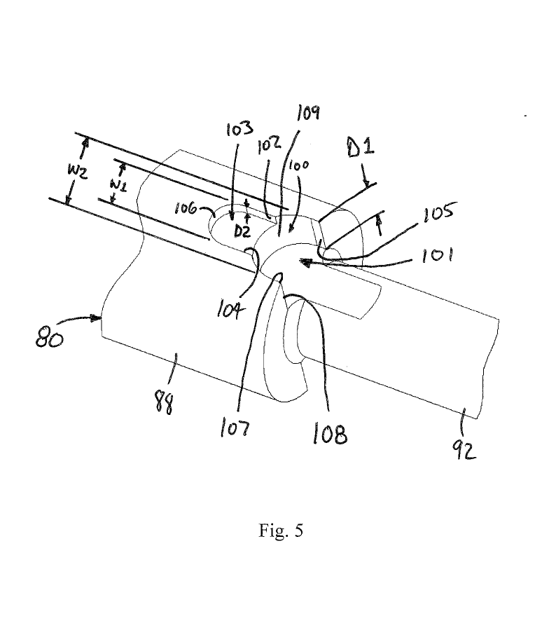

An exemplary slot 100 configured to have a varying exit angle α is shown in FIG. 5. The slot 100 may be formed in the first land 88 of the valve element 80 described above. The slot 100 may be formed as a complex slot having discrete sections with associated physical attributes. As used herein, a “physical attribute” may be a slot depth, a slot width, a slot length, a slot radius of curvature, or any other physical dimension or feature of the structure defining the slot. In the exemplary embodiment, the slot 100 has a physical attribute with a first value at one end of the slot and a second value, different from the first value, at the opposite end of the slot.

More specifically, the slot 100 may include a first slot area 101 and a second slot area 103. The first slot area 101 may include generally opposing side walls 105, 107 connected by a first terminal end wall 109. Similarly, the second slot area 103 may include generally opposing side walls 102, 104 connected by a second terminal end wall 106. In the illustrated embodiment, the side walls 102, 104, 105, 107 may be generally planar, while the first and second terminal end walls 106, 109 may be arcuate, however other shapes and orientations may be used. At an open end 108, the first slot area 101 may have a first depth D1 and a first width W1, while at the slot terminal end 99 the second slot area 103 may have a second depth D2 and a second width W2. The depths and widths of the first and second slot area 101, 103 may influence the resulting exit angle α of fluid flowing through the slot 100. More specifically, a slot having a relatively narrower width and a relatively deeper depth may tend to generate a larger exit angle α while a slot having a relatively wider width and relatively a shallower depth may tend to generate a smaller exit angle α.

Accordingly, the slot 100 may include portions having different slot configurations to generate different exit angles at different positions of the valve element. In the exemplary embodiment, therefore, the slot 100 may be configured so that the first depth D1 is greater than the second depth D2, and the first width W1 is smaller than the second width W2. Thus, when the valve element 80 is in the first position, the entire slot 100 may influence the resulting exit angle α, and therefore providing a portion of the slot 100 near the open end 108 with a greater depth D1 and narrower width W1 may help generate a larger exit angle α. By contrast, when the valve element 80 is in the second position, the terminal end of the slot 100 may have a greater influence on the resulting exit angle α, and therefore a shallower depth D2 and a larger width W2 in this portion of the slot 100 may help generate a smaller exit angle α. With this configuration, the slot 100 may be configured to reduce exit angle α as the valve element 80 moves from the first position to the second position, thereby to compensate for the reduction in differential pressure and maintain a more consistent slot flow force 96 across the entire range of travel of the valve element 80.

### INDUSTRIAL APPLICABILITY

The present disclosure may be applicable to machines having one or more hydraulic circuits that include a regeneration valve for executing a quick drop of an implement or tool. The regeneration valve embodiments disclosed herein may include a valve element 80 that is responsive to fluid flow rate through the regeneration valve to automatically actuate from a first position to a second position. The use of a flow rate responsive valve, as opposed to pressure responsive or pilot actuated valves, may reduce the number of parts and cost needed for the regeneration valve.

Under normal operating conditions, the regeneration valve 70 may be typically in the first position shown in FIG. 2, where the first port 74 fluidly communicates with the second port 75 and the third port 76 is closed. With the regeneration valve 70 in the first position, the lift cylinders 32a, 32b may execute a controlled extension or a controlled retraction. During controlled extension, the control valve 52 may be actuated to a position in which the pump 38 fluidly communicates with the head ends 54 and the reservoir 46 fluidly communicates with the rod ends 56. In this configuration, pressurized hydraulic fluid may flow into the head ends 54, while hydraulic fluid in the rod ends 56 may drain into the reservoir 46, so that the pistons 58 may move downwardly in a controlled fashion. During a controlled retraction, the control valve 52 may be actuated to a different position in which the pump 38 fluidly communicates with the rod ends 56 and the reservoir 46 fluidly communicates with the head ends 54. In this configuration, pressurized hydraulic fluid may flow into the rod ends 56, while hydraulic fluid in the head ends 54 may drain into the reservoir, so that the pistons 58 may move upwardly in a controlled fashion. During both controlled extensions and controlled retractions, the pilot passage 86 may communicate hydraulic fluid to the resilient member chamber 84, which may assist the resilient member 82 in holding the valve element 80 in the first position.

If instead the operator desires to execute a quick drop by using the weight of the blade 28 to quickly extend the lift cylinders 32a, 32b, the valve element 80 of the regeneration valve 70 may automatically actuate to the second position to minimize cavitation and lag. During a quick drop, the weight of the blade 28 may tend to quickly extend the cylinders 32a, 32b by rapidly pulling the pistons 58 downwardly. The rapid movement of the pistons 58 may push hydraulic fluid in the rod ends 56 through the second conduit 66 and into the second port 75 of the regeneration valve 70. With the valve element 80 still in the first position, the hydraulic fluid may initially flow from the second port 75 to the first port 74 and on to the reservoir 46. When the rate of fluid flow from the second port 75 to the first port 74 exceeds a threshold, however, the valve element may automatically and hydro-mechanically move toward the second position to divert a portion of the returning hydraulic fluid to the third port 76 and on to the head ends 54. Specifically, as noted above, the valve element 80 may include a flow slot 94 that is configured to generate a slot flow force 96 resulting from the flow of fluid through the flow slot 94, wherein the slot flow force 96 is directed to push the valve element 80 toward the second position.

The flow slot 94 may be configured so that the slot flow force 96 is maintained at a sufficient magnitude throughout the range of travel of the valve element 80 within the chamber 78. For example, the flow slot 94 may be configured to have a relatively steep exit angle when the valve element 80 is at or near the first position, and a relatively shallow exit angle when the valve element 80 is at or near the second position. When configured in this manner, the change in exit angle will compensate for the drop in pressure differential across the valve element 80 as the valve element 80 moves from the first position to the second position, thereby to help maintain a slot flow force 96 that is sufficient to move the valve element 80 against the biasing force of the resilient member 82 and toward the second position.

The valve element 80 may return to the first position when the hydraulic fluid flow rate from the second port 75 to the first port 74 falls below the flow rate threshold, so that the force from the resilient member 82 exceeds the slot flow force 96. As a practical example, this may occur when the blade 28 reaches the ground. Once the valve element 80 returns to the first position, pressurized hydraulic fluid may be communicated to the resilient member chamber 84 by the pilot passage 86, to once again assist in holding the valve element 80 in the first position. Once the head ends 54 are completely full of hydraulic fluid, the cylinders 32a, 32b may be further extended to push the blade 28 below ground level.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A regeneration valve for a hydraulic circuit having a hydraulic fluid flowing therethrough, the regeneration valve comprising:
a housing defining a first port, a second port, and a third port;
a chamber formed in the housing and fluidly communicating with the first, second, and third ports;
a valve element disposed in the chamber and movable between a first position, in which the second port fluidly communicates with the first port, and a second position, in which the second port fluidly communicates with the third port;
a resilient member coupled to the valve element and configured to apply a biasing force on the valve element toward the first position; and
a flow slot formed in the valve element and fluidly communicating with the hydraulic fluid flowing through the chamber, the flow slot being configured to define a slot fluid flow that generates a slot flow force acting on the valve element that is sufficient to actuate the valve element to the second position at a predetermined hydraulic fluid flow rate from the second port to the first port.

2. The regeneration valve of claim 1, wherein the valve element includes first and second lands coupled by a spool rod.

3. The regeneration valve of claim 2, wherein the flow slot is formed in the first land.

4. The regeneration valve of claim 2, wherein the flow slot is formed in both the first and second lands.

5. The regeneration valve of claim 1, wherein the hydraulic circuit includes a hydraulic cylinder having a cylinder rod end and a cylinder head end, and wherein the first port fluidly communicates with a fluid reservoir, the second port fluidly communicates with the cylinder rod end, and the third port fluidly communicates with the cylinder head end.

6. The regeneration valve of claim 5, wherein the housing defines a resilient member chamber configured to receive the resilient member, and a pilot passage fluidly communicating between the resilient member chamber and a pilot signal.

7. The regeneration valve of claim 1, wherein the slot fluid flow exits the slot at an exit angle, and wherein the slot is configured to have a larger exit angle with the valve element in the first position and a smaller exit angle with the valve element in the second position.

8. The regeneration valve of claim 7, wherein the flow slot is formed in a periphery of the valve element and includes opposed side walls joined by a terminal end wall, the flow slot defining a terminal end adjacent the terminal end wall and an open end opposite the terminal end.

9. The regeneration valve of claim 8, wherein the flow slot has a physical attribute having a first value at the flow slot open end and a second value, different from the first value, at the flow slot terminal end.

10. The regeneration valve of claim 9, wherein the physical attribute is selected from the group consisting of a slot depth, a slot width, a slot length, and a slot radius of curvature.

11. The regeneration valve of claim 8, wherein the flow slot has a first slot depth and a first slot width at the flow slot open end, and a second slot depth and a second slot width at the flow slot terminal end, wherein the first slot depth is different from the second slot depth and the first slot width is different from the second slot width.

12. A hydraulic circuit for a machine implement, the hydraulic circuit comprising:
a pressurized hydraulic fluid source;
a fluid reservoir;
a hydraulic cylinder having a cylinder head end and a cylinder rod end;
a regeneration valve including:
a housing defining a first port fluidly communicating with the fluid reservoir, a second port fluidly communicating with one of the cylinder head end and the cylinder rod end, and a third port fluidly communicating with both the pressurized fluid source and a remaining one of the cylinder head end and the cylinder rod end;
a chamber formed in the housing and fluidly communicating with the first, second, and third ports;
a valve element disposed in the chamber and movable between a first position, in which the second port fluidly communicates with the first port, and a second position, in which the second port fluidly communicates with the third port;
a resilient member coupled to the valve element and configured to apply a biasing force on the valve element toward the first position; and
a flow slot formed in the valve element and fluidly communicating with the hydraulic fluid flowing through the chamber, the flow slot being configured to define a slot fluid flow that generates a slot flow force acting on the valve element that is sufficient to actuate the valve element to the second position at a predetermined hydraulic fluid flow rate from the second port to the first port.

13. The hydraulic circuit of claim 12, wherein the valve element includes first and second lands coupled by a spool rod.

14. The hydraulic circuit of claim 13, wherein the flow slot is formed in the first land.

15. The hydraulic circuit of claim 13, wherein the flow slot is formed in both the first and second lands.

16. The hydraulic circuit of claim 12, wherein the housing defines a resilient member chamber configured to receive the resilient member, and a pilot passage fluidly communicating between the resilient member chamber and a pilot signal.

17. The hydraulic circuit of claim 12, wherein the slot fluid flow exits the slot at an exit angle, and wherein the slot is configured to have a larger exit angle with the valve element in the first position and a smaller exit angle with the valve element in the second position.

18. The hydraulic circuit of claim 17, wherein the flow slot is formed in a periphery of the valve element and includes opposed side walls joined by a terminal end wall, the flow slot defining a terminal end adjacent the terminal end wall and an open end opposite the terminal end.

19. The hydraulic circuit of claim 18, wherein the flow slot has a first slot depth and a first slot width at the flow slot open end, and a second slot depth and a second slot width at the flow slot terminal end, wherein the first slot depth is different from the second slot depth and the first slot width is different from second slot width.

20. The hydraulic circuit of claim 12, wherein the second port fluidly communicates with the cylinder rod end and the third port fluidly communicates with the cylinder head end.
